(19) United States
(12) Patent Application Publication
(10) Pub. No.: US 2010/0153513 A1
(43) Pub. Date: Jun. 17, 2010

(54) WIRELESS DATA CHANNELING DEVICE AND METHOD

(76) Inventor: Ahmad ZAHRAN, Dubai (AE)

Correspondence Address: NIXON PEABODY, LLP, 401 9TH STREET, NW, SUITE 900, WASHINGTON, DC, 20004-2128, US

(21) Appl. No.: 12/508,730

(22) Filed: Jul. 24, 2009

(30) Foreign Application Priority Data
Dec. 17, 2008 (ZA) 2008/10627

(51) Int. Cl. G06F 15/16

(52) U.S. Cl. 709/212

(57) ABSTRACT

A wireless data channeling device associated with a host computer is provided, the host computer comprising data that is deemed to be visible with respect to the data channeling device. The data channeling device comprises a connector to allow the device to be fitted to a device that is remote from the host computer, a device transceiver to enable the device to receive/transmit data from/to a host transceiver of the host computer, and a controller for functionally connecting the connector to the host transceiver. Thus, when in a data channeling mode, the visible data on the host computer can be wirelessly transmitted to the remote device via the data channeling device and/or data on the remote device can be transmitted to the host computer via the data channeling device. In an example embodiment, the connector is similar to a connector of a traditional USB flash memory disk so that, when connected to the remote device, the data channeling mimics a standard, off-the-shelf memory stick.

### FIELD OF THE INVENTION

This invention relates to a wireless data channeling device and method, and in particular to a device and method that extends the capabilities of the traditional USB flash drive (also known as ‘memory stick’ or ‘flash memory’) to mimic a data storage device having ‘infinite’ data storage capacity.

### BACKGROUND TO THE INVENTION

USB flash drives are well known and used. However, these devices are limited by the physical capacity of the memory chip used to provide the storage requirements in these devices. The experience of end users of these devices is generally identical; when he/she uses a standard USB flash drive to upload or download files onto/from the flash drive he/she will notice that the amount of data that can be stored on these flash drives is always limited.

### OBJECT OF THIS INVENTION

It is thus an aim of the present invention to provide a device that mimics traditional USB flash drives but that effectively provides the user with unlimited storage capacity.

### SUMMARY OF THE INVENTION

According to a first aspect of the invention there is provided a wireless data channeling device associated with a host computer device, the host computer device comprising data that is deemed to be visible with respect to the data channeling device, the data channeling device comprising:
a connector to allow the device to be fitted to a remote client device that is remote from the host computer;
a device transceiver to enable the device to receive/transmit data from/to a host transceiver of the host computer device; and
a controller for functionally connecting the connector to the host transceiver so that, when in a data channeling mode, the visible data on the host computer device can be wirelessly transmitted to the remote client device via the data channeling device and/or data on the remote client device can be transmitted to the host computer device via the data channeling device.

In an example embodiment, the connector is similar to a connector of a traditional USB flash memory disk, with the controller having firmware so that when connected to the remote client device, the data channeling device mimics a standard, off-the-shelf memory stick.

In an example embodiment, the data channeling device comprises a pairing switch to enable the device to be switched between the data channeling mode and a pairing mode in which the data channeling device is paired to the host computer device.

In an example embodiment, the device transceiver comprises a wireless device transceiver utilizing a wireless technology that allows the data channeling device to be bridged to the host computer.

In an example embodiment, the wireless device transceiver of the data channeling device is paired to a corresponding wireless host transceiver of the host computer device so that the two wireless transceivers can create a wireless bridge between them through which data can be transferred in real time.

In an example embodiment, the wireless transceivers communicate with each other using a WI-FI™ 802.11 wireless communications protocol.

In an example embodiment, a WI-FI™ signal of the host computer device can be split into a plurality of signals, at least one of which is used to create the wireless bridge.

Alternatively, the wireless transceivers may communicate with each other using any other wireless communications protocol, such as BLUETOOTH™.

In an example embodiment, the controller is arranged to format the data being transferred from the host computer device to the remote client device so that it can be read by the remote client device as if the data channeling device were a traditional memory stick.

In an example embodiment, the data channeling device comprises a LED indicator to indicate the signal strength between the data channeling device and the host computer device.

According to a second aspect of the invention there is provided a method of pairing a wireless data channeling device with a host computer device, the host computer device comprising data that is deemed to be visible with respect to the data channeling device and further comprising a host transceiver, the data channeling device comprising a connector to allow the device to be fitted to the host computer device and to a remote client device that is remote from the host computer device, a device transceiver to enable the device to receive/transmit data from/to a host transceiver of the host computer device, and a controller for functionally connecting the connector to the host transceiver, the method comprising the steps of:
installing user interface software associated with the data channeling device onto the host computer device;
selecting a pairing mode on the data channeling device;
connecting the data channeling device to the host computer device;
activating the user interface software, this prompting a user to confirm that the data channeling device is to be paired with the host computer device; and
once confirmed, programming the device transceiver to be bridged only to the host transceiver.

In an example embodiment, the method comprises removing the data channeling device from the host computer device and selecting a data channeling mode on the data channeling device so that the visible data on the host computer device can be wirelessly transmitted to the remote client device via the data channeling device and/or data on the remote client device can be transmitted to the host computer device via the data channeling device.

According to a third aspect of the invention there is provided a wireless data channeling system comprising:
a host computer device, the host computer device comprising data that is deemed to be visible; and
a data channeling device comprising:
a connector to allow the device to be fitted to a remote client device that is remote from the host computer device;
a device transceiver to enable the device to receive/transmit data from/to a host transceiver of the host computer device; and

a controller for functionally connecting the connector to the host transceiver so that, when in a data channeling mode, the visible data on the host computer device can be wirelessly transmitted to the remote client device via the data channeling device and/or data on the remote client device can be transmitted to the host computer device via the data channeling device.

### BRIEF DESCRIPTION OF THE DRAWINGS

A preferred embodiment of the invention will be described, by way of example only, with reference to the drawings in which:

FIG. 1 shows a schematic view of a data channeling device according to an example embodiment of the present invention;

FIG. 2 shows a schematic block diagram of the data channeling device shown in FIG. 1;

FIG. 3 shows a schematic view of data being wirelessly transmitted to and from a host computer device via the data channeling device shown in FIG. 2;

FIG. 4 shows a schematic screen shot of the data channeling device connected to the host computer device and being uniquely associated with the host computer device;

FIG. 5 shows schematic screen shots on the host computer device and a remote client computer device when the data channeling device is connected to the remote client computer device; and

FIG. 6 shows a schematic flow chart illustrating a method of pairing a wireless data channeling device with a host computer device, according to an example embodiment of the present invention.

### DESCRIPTION OF PREFERRED EMBODIMENTS

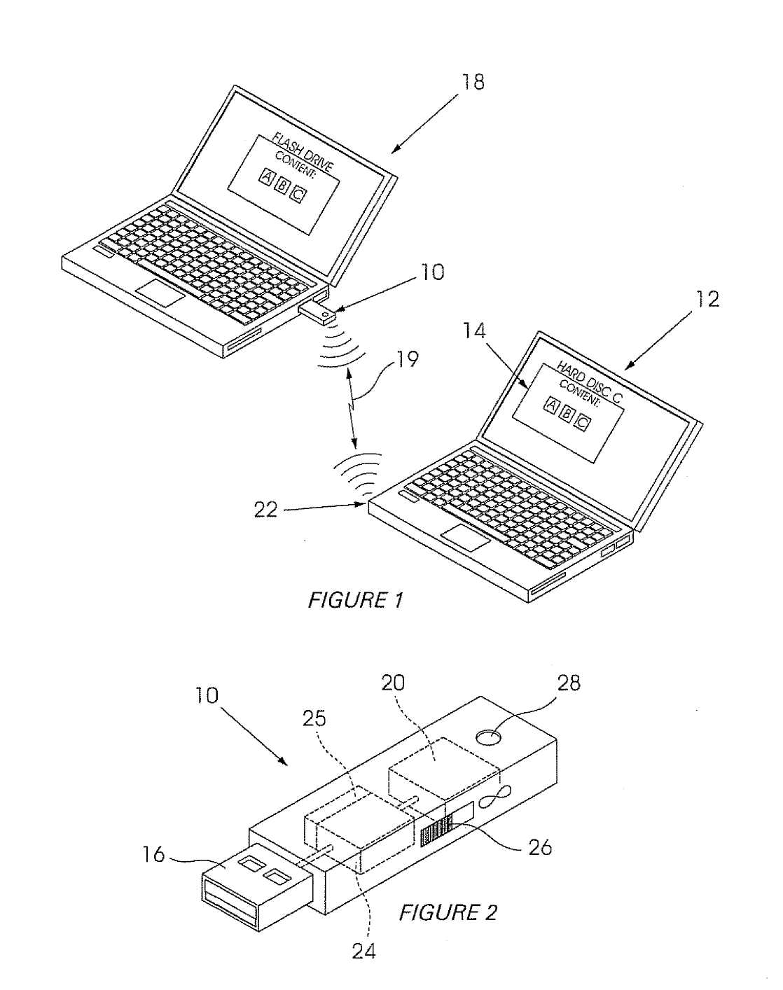

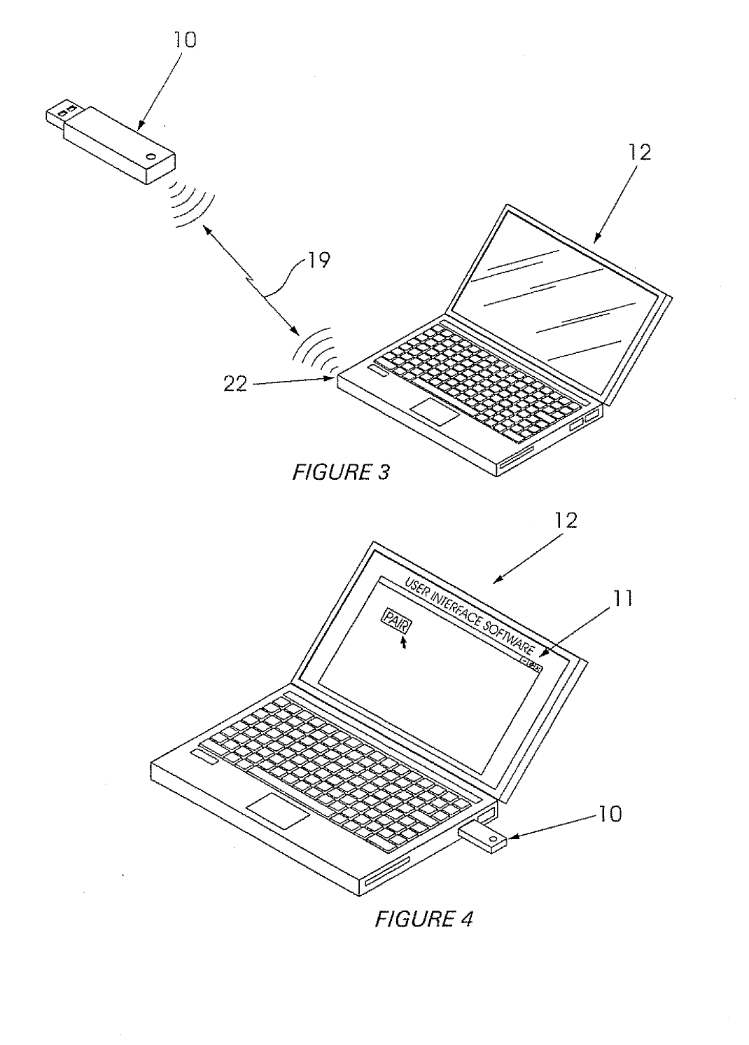

Referring first to FIGS. 1 to 3, a wireless data channeling device 10 associated with a host computer device 12 is provided, the host computer device 12 comprising data 14 that is deemed to be visible with respect to the data channeling device 10.

As best shown in FIG. 2, the data channeling device 10 comprises a connector 16 to allow the device 10 to be fitted to a remote client device 18 that is remote from the host computer device 12, a device transceiver 20 to enable the device 10 to receive/transmit data from/to a host transceiver 22 of the host computer device 12, and a controller 24 for functionally connecting the connector 16 to the host transceiver 22 so that, when in a data channeling mode, the data 14 on the host computer device 12 can be wirelessly transmitted to the remote client device 18 via the data channeling device 10 and/or data on the remote client device 18 can be transmitted to the host computer device 12 via the data channeling device 10.

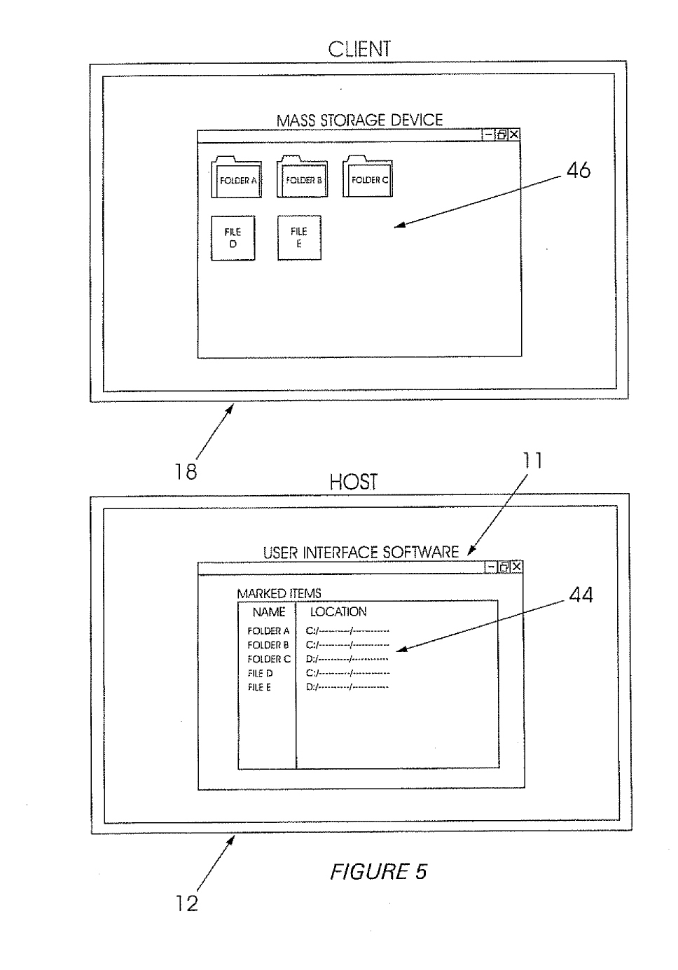

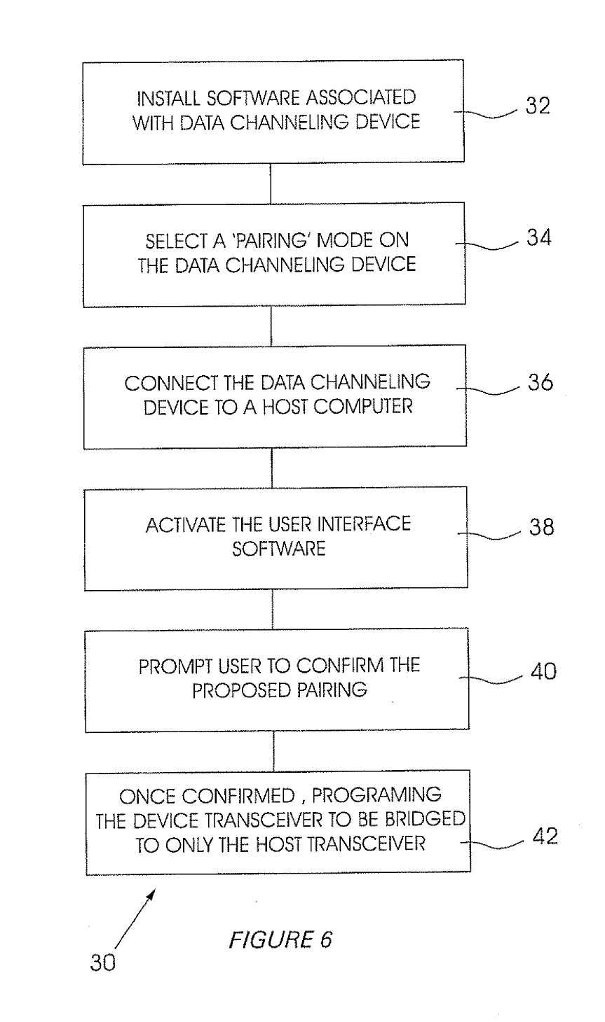

The controller 24 may include a small internal memory 25 in order to help with caching and to store a setup file for the user interface software 11 (shown in FIGS. 4 and 5) that is to run on the host computer device 12, which will described in more detail further below with reference to FIG. 6 of the accompanying drawings.

An important feature of the present invention is thus that the data channeling device 10 is at all times bridged, as indicated by arrow 19, to a host computer device 12 which is controlling the contents that the remote client device 18 presumes to be on the flash memory 10. In fact the data channeling device 10 does not store any content on the device 10 itself but instead transfers all data to and from a host computer device 12, therefore allowing the host computer device 12 to control in real time which information is visible on the data channeling device 10. In other words, the data channeling device 10 is not actually a memory drive in itself since there is no physical memory chip on the drive (except for the small internal memory 25 as described above).

In an example embodiment, the connector 16 is similar to a connector of a traditional USB flash memory disk so that, when connected to the remote client device 18, the data channeling device 10 mimics a standard, off-the-shelf memory stick. Thus, the front-end of the data channeling device 10 comprises a standard male type-A USB connector which has no intelligence and is well known in the art. The connector 16 is used to provide the data channeling device 10 with connectivity to any remote client device 18 with has a standard USB interface, such as a computer, PLAYSTATION 3™, DVD player and a plurality of other devices. When the data channeling device 10 is in the data channeling mode, the connector 16 of the data channeling device controller 24 is the section of the data channeling device 10 that communicates with the remote client device 18. As such, the first thing that the connector 16 of this device 10 needs to do is to allow the remote client device 18 to recognize the data channeling device 10 as merely a standard, off-the-shelf USB flash drive. By doing this, the data channeling device 10 will be able to run without needing any driver to be manually installed on either the host computer device 12 or the remote client device 18, and will therefore become a plug-and-play device. The data channeling device controller 24 can do this by mimicking a USB mass storage controller, which is the device that controls a traditional USB flash drive. As such, the connector 16 can feed information to the host computer device 12 using the UMS (USB mass storage device class or USB MSC) protocol.

In an example embodiment, the data channeling device 10 comprises a mode selection switch 26 to enable the device 10 to be switched between the data channeling mode and a pairing mode in which the data channeling device 10 is paired to the host computer device 12. The pairing mode also allows the data channeling device 10 to be paired to a new host. When the switch 26 is positioned in the ‘pair’ mode, as shown in FIG. 4, the data channeling device 10 will search the host computer device 12 that it is connected to for a WI-Fi™ host transceiver 22 that it can bridge with, as will be described in more detail further on in the specification. The data channeling mode is also referred to as an infinite mode, in which the data channeling device 10 will be seen by remote client devices 18 as simply another standard USB memory stick. Moreover, when it is attached to a remote client device 18, it will constantly search for its host computer device 12 with which to establish a bridge 19.

In an example embodiment, the device transceiver 20 comprises a wireless 802.11 WI-FI™ chip that allows the data channeling device 10 to be bridged to the host computer device 12. In particular, the WI-FI™ device transceiver 20 of the data channeling device 10 is paired to a 802.11 WI-FI™ host transceiver 22 of the host computer device 12 so that the two 802.11 transceivers can create a wireless bridge 19 between them through which data can be transferred in real time.

In one version, the user interface software 11 running on the host computer device 12, which will be described in more detail below with reference to FIG. 6, controls the WI-FI™ host transceiver 22 of the host computer device 12 in order to split the WI-FI™ signal and allow connection to two simultaneous devices, namely the WI-FI™ network for internet/intranet connectivity and the data channeling device 10. Thus, in this version, the user interface software 11 provides a dual WI-FI™ connection.

As indicated above, the device transceiver 20 may alternatively comprise a wireless transceiver utilizing any other wireless technology, such as BLUETOOTH™, that allows the data channeling device to be bridged to the host computer. Accordingly, the wireless device transceiver 20 of the data channeling device may be paired to a corresponding wireless host transceiver 22 of the host computer so that the two wireless transceivers can create a wireless bridge between them through which data can be transferred in real time.

In an example embodiment, the controller 24 is arranged to format the data being transferred from the host computer device 12 to the remote client device 18 so that it can be read by the remote client device 18 as if the data channeling device 10 were a traditional memory stick. When the data channeling device 10 is in the data channeling mode, the controller's main aim is to act as a mediator of information between the host computer device 12 and the remote client device 18. More specifically, it aims to translate the signals arriving from the wireless bridge 19 to a mass storage format that the remote client device 18 can understand, and vice versa. The other area of responsibility of the controller 24 is to create and maintain the wireless bridge 19 between the host computer device 12 and the data channeling device 10.

When the data channeling device 10 is in the ‘pair’ mode, the controller's main aim is to find the host computer's WI-FI™ host transceiver 22 and pair with it. Once it has done this, the controller 24 will memorize the information of that host transceiver 22 in order to be able to find it at any time later when the data channeling device 10 is in its data channeling mode. As a mediation device, the controller 24 is in charge of protocol translation between the WI-FI™ device transceiver 20 and the host computer device 12. Therefore, the largest responsibility of the data channeling device controller 24 is the quick and efficient translation of data packet from UMS to 802.11 protocol and vice-versa. This type of translation is not a common requirement in the industry. When the data channeling device 10 is in its ‘infinite’ mode, the data channeling device controller 24 also has the responsibility of setting up and maintaining a wireless bridge 19 between the 802.11 device transceiver 20 on the data channeling device 10 and the 802.11 host transceiver 22 on the host computer device 12. This can be achieved simply by utilizing the standard 802.11 protocols. The controller 24 must be able to communicate with the 802.11 device transceiver 20 much in the same way as a normal laptop would communicate with this transceiver. The controller 24 will request from the 802.11 device transceiver 20 that it finds the WI-FI™ signal from the host's 802.11 host transceiver 22 and thereafter bridge with it. The controller 24 must also be able to read the signal strength of the wireless bridge 19 and display this as a set of colors on a LED indicator 28 of the data channeling device 10. This is especially critical when the signal deteriorates to the point where the wireless bridge 19 is broken and the connection is lost.

When the data channeling device 10 is in its ‘pair’ mode, the controller 24 will passively wait for the controller's firmware to identify which WI-FI™ host transceiver 22 to pair with. Once the user has followed the pairing instructions and accepted the pairing, the user interface software 11 will push the MAC address of the 802.11 host transceiver 20 to be stored onto the controller's memory 25. Thereafter, this MAC address will be the only wireless bridge 19 that the data channeling device 10 will attempt to establish a connection with. Each data channeling device 10 can only be bridged to one single host computer at any time. However, if the user wishes to change the host that a data channeling device 10 is paired to, he/she can do so an unlimited number of times This means that the MAC address of the WI-FI™ host transceiver 22 can be re-programmed into the controller 24 at any time without a limit as to the number of times this can be done.

As indicated in the preceding paragraph, the data channeling device 10 comprises an LED indicator 28 to indicate the signal strength between the data channeling device 10 and the host computer device 12. A green light may indicate a strong WI-FI™ signal, yellow may indicate a low signal and red may indicate that a signal from the host computer device 12 cannot be found.

Turning now to FIG. 6, the data channeling device 10 has to be programmed as soon as it is purchased and taken out of the box. The programming is easily done through a user interface software 11 that is easy to use and will be provided with every purchased data channeling device 10. Thus, and according to a second aspect of the invention, there is provided a method 30 of pairing a wireless data channeling device 10 with a host computer device 12, the host computer device 12 comprising data that is deemed to be visible with respect to the data channeling device 10 and further comprising a host transceiver 22, the data channeling device 10 comprising a connector 16 to allow the device 10 to be fitted to the host computer device 12 and to a remote client device 18 that is remote from the host computer device 12, a device transceiver 20 to enable the device 10 to receive/transmit data from/to a host transceiver 22 of the host computer device 12, and a controller 24 for functionally connecting the connector 16 to the host transceiver 22.

In broad terms, the method 30 comprises the steps of installing the user interface software 11 associated with the data channeling device onto the host computer, as indicated by block 32. The user has to thereafter select a pairing mode on the data channeling device 10, typically by setting the mode selection switch 26 on the side of the data channeling device 10 to ‘pair’ mode, as indicated by block 34. The data channeling device 10 is then connected to the host computer device 12, typically by inserting the data channeling device 10 into the USB slot of the computer which it will be paired it to, as indicated by block 36. After activating the user interface software 11, typically through the click of a button, as indicated by block 38, the user interface software 11 prompts a user to confirm that the data channeling device 10 is to be paired with the host computer device 12, as indicated by block 40. Once confirmed, the method 30 concludes by programming the device transceiver 20 to be bridged only to the host transceiver 22, as indicated by block 42. Once confirmed and programmed, the controller 24 of the data channeling device 10 will only recognize bridging requests from the host transceiver 22 of the host computer device 12. To do this, as described above, the MAC address of the host transceiver 22 will be programmed into the data channeling device controller 24 as the sole host for that specific data channeling device 10.

In an example embodiment, the method 30 comprises removing the data channeling device 10 from the host computer device 12 and selecting a data channeling mode on the data channeling device 10 so that the visible data on the host computer device 12 can be wirelessly transmitted to the remote client device 18 via the data channeling device 10 and/or data on the remote client device 18 can be transmitted to the host computer device 12 via the data channeling device 10. This is typically achieved by removing the data channeling device 10 and setting the switch 26 to ‘infinite’/data channeling mode. Once the data channeling device 10 has been paired to a host computer device 12 and the switch has been moved back to the ‘infinite’ position, it can be inserted into the USB port of any remote client device 18, with the client device then seeing the data channeling device 10 as if it was a simple flash memory drive, as described above.

In more detail, the method 30 of pairing a wireless data channeling device 10 with a host computer device 12 operates as follows:
1. The wireless data channeling device 10 is connected to the host computer device 12 and the ‘pair’ mode is selected.
2. The host computer device 12 identifies the data channeling device 10 as a “USB Mass Storage”.
3. The user interface software 11 stored on the internal memory 25 within the data channeling device 10 auto-runs.
4. The user interface software 11 checks to see whether any version of the user interface software 11 is installed on the host computer device 12.
   a. If not, the user interface software 11 installs itself and auto-starts.
   a. If yes, the user interface software 11 is opened.
5. The user interface software 11 checks the version of the software (both the user interface software 11 and the firmware of the data channeling device 10) against information stored on a world webserver.
   a. If they are not the latest versions, the user interface software 11 prompts the user to download the latest user interface software 11 and/or firmware and install.
   b. If the host computer device 12 and data channeling device 10 has the latest user interface software 11 and firmware, the user is notified of this.
6. The user interface software 11 checks the data channeling device 10 configuration to see if it is already paired to another machine (in other words, whether there is an existing configuration).
   a. If yes, the user is warned that the data channeling device 10 is already paired to another machine.
   b. If no, the user is notified that configuration is required.
7. The user clicks on ‘Pair Device’ button.
8. The user interface software 11 loads the data channeling device 10 with the host computer settings (MAC Address, etc.) and also saves the information of the data channeling device 10 to the host computer device 12.
   a. If settings are successfully loaded on both the data channeling device 10 and the host computer device 12, the user is notified that the configuration was successful.
   b. If settings are unsuccessful, configuration is attempted. If this fails a second time, the user is notified that the configuration was unsuccessful, and the process terminates.
9. If the configuration is successful, the user interface software 11 saves the configuration settings of the existing WI-FI™ connection, if one exists, for rollback scenarios and use in the dual WI-FI™ connections.
10. The user interface software 11 activates its internal WI-FI™ controller function and takes over the host computer WI-FI™ interface and configures WI-FI™ for peer-to-peer connection to the data channeling device 10, with this connection being referred to below as Virtual Interface A.
11. The user interface software 11 connects to the data channeling device 10 over the WI-FI™ interface (Virtual Interface A) to test the connection.
   a. If Virtual Interface A fails, it is reconfigured and retested. If it fails a second time, the user is notified of this pairing failure and the original WI-FI™ configuration is reset and the user interface software 11 controlling the WI-FI™ interface is disabled.
   b. If successful, the process continues.
12. The user interface software 11 runs the existing configuration obtained in point 9 above for WI-FI™ Virtual Interface B, relating to the Internet/Intranet, and confirms authentication.
   a. If authentication failures, it is reconfigured and retested. If it fails a second time, the user is notified of the Internet/Intranet connection failure and is asked to confirm if they want to proceed without Internet/intranet connectivity.
      i. If yes, the WI-FI™ Virtual Interface B configuration is removed, with the peer-to-peer configuration only then being allowed.
      ii. If no, the user is notified that pairing will not continue, the original configuration is reset and the user interface software 11 controlling the WI-FI™ interface is disabled, and the user is then notified.
   b. If the authentication is successful, the process continues.
13. The user is notified of the successful pairing, and the data channeling device 10 is ready for the ‘infinite’ mode.
14. The user may then eject the data channeling device 10, which will then be ready for use with any remote client device 18, such as the remote client device 18 in FIG. 1, within WI-FI™ radius of the host computer device 12.

In use, once the data channeling device 10 is paired with a host computer device 12 and connected to a remote client device 18, the client's operating software (WINDOWS™, MAC OSX™, LINUX™, etc) will try to read the data channeling device 10 as it would any other standard memory stick. If the host computer device 12 is within wireless proximity of the data channeling device 10 and the wireless bridge 19 is operational, the remote client device 18 will succeed in opening the root directory of the data channeling device 10 on the host computer device 12. This root directory will initially appear to be empty until it gets populated by the host computer device 12. The host computer device 12 can run user interface software 11 to allow the host user to mark which files and folders are to become visible to the data channeling device 10. Marking a file/folder can be done by dragging and dropping the file/folder into the user interface software 11 or by right-clicking on the file/folder and checking an option to mark it. Once a file or folder is marked as ‘visible’, it will appear in the root directory of the internal memory 25 on the remote client device 18. At this point the client user will be able to open or copy the files or folders into their computer.

Similarly, the remote client device 18 can also use the data channeling device 10 to upload data files onto the host computer device 12. The host computer device 12 will perceive the files to be uploading onto the memory stick when in fact they are being uploaded into the host computer device 12 via the wireless bridge 19. Any files that are visible on the client's side can be immediately accessed or copied to the host's hard drive. Typically, if the client wishes to upload any information onto the data channeling device 10, this can easily be done by dragging any file or folder from the remote client device 18 into the device's root directory. Any file that is dragged into the root directory will immediately be uploaded into the host's hard drive to a predefined folder location.

Files accessed by the client will typically be downloaded as temporary files into the client's hard drive until they are saved or closed, at which point they will be erased from the temporary folder. Copied files on the other hand will be immediately downloaded and saved to the location that the client has specified. The speed of downloading the files will depend mainly on the speed and quality of the wireless bridge 19. As such, distance and interference will be the two main factors that influence the quality of the bridge connection 19. Higher quality will mean faster download speed. Additionally, the bridge 19 can be created over 802.11a, b, g or n links, depending on the transceivers on both the host computer device 12 and the data channeling device 10. As such, each one of these protocols will provide a different access speeds as per 802.11 specifications. Additionally, alternate versions of the product that use alternate wireless technologies such as BLUETOOTH™ may create the bridge using these technologies.

Since the files are at no time stored on the data channeling device 10 itself what the data channeling device 10 is doing is merely providing a ‘tunnel’ through which the client can see and access files that are in fact on the host computer device 12 or send files directly to the host computer's hard drive. This ‘tunnel’ is similar to a wormhole tunnel in the sense that it allows a user on one end to see and access something that is far away whilst perceiving that it is within physical grasp. Similarly, the data channeling device 10 allows the client user to access and upload information on another hard drive while keeping the perception that the information is locally stored on the data channeling device itself.

The user interface software 11 on the host computer device 12 therefore has three main functions:

1. It programs the data channeling device 10 in order to pair it to the host computer device 12 which is running the user interface software 11. This can happen only when the data channeling device 10 has been switched to its ‘pair’ mode or position.

2. It provides the host computer device 12 user a simple method for marking the files and folders that will become visible to the client when the switch 26 is on the ‘infinite’ position.

3. Also when the switch 26 is in the ‘infinite’ position, the user interface software 11 will allow the host computer device 12 to configure which directory or location on the host computer device 12 where uploads can be stored in and thereafter will be able to receive any uploads from the remote client device 18.

As described above, when the data channeling device 10 is in its ‘infinite’ mode, the user interface software 11 will serve as the controlling software for the device. As shown in FIG. 5 the user will have full control of which files or folders to mark as visible to the client. The user interface software 11 will give the host user a simple yet efficient way of marking any or all files on the host computer device 12 as being visible to the remote client device 18. In addition, the host computer device 12 can also mark any files or folders 44 on any external hard drives or shared networks that the host computer device 12 is connected to. These marked files which are on hard drives other than the host computer's will also appear to the client in the root directory 46 of the memory drive in the same way all other files are. The remote client device 18 may not be able to distinguish between files on the host's hard drive and files on the host's network.

The data channeling device 10 of the present invention has a number of possible uses, including:

Replacement of the Traditional USB Flash Drive

The first and most obvious use of this product is to replace the traditional memory-restricted flash drives. The data channeling device 10 provides a method by which users are no longer limited by the physical memory restrictions of 1, 2, 10 or even 20 GB. Instead, the user can transfer the entire contents of his/her hard drive if they so choose. Not only are the capacity limitations removed, but this method of file sharing is generally much faster in that on the data channeling device 10 both upload and download happen simultaneously in real-time.

Gaming Systems or Consoles

On the PLAYSTATION 3™, for example, there is a method by which the USB port on the PLAYSTATION 3™ can be connected to external mass storage devices. When a mass storage device like a hard drive or a USB flash drive is connected, the PLAYSTATION 3™ will read the information on it in order to play any media files that it contains. This feature is extremely popular because it allows users to play movies, songs or pictures through the PLAYSTATION 3™. Most users generally have this type of multimedia content stored on their computer hard drives. When they wish to play this content on the PLAYSTATION 3™ they need to first transfer this content onto an external hard drive or a USB flash drive. Instead of having to do this, the data channeling device 10 provides the user a method to be able to play all of his/her media content on the PLAYSTATION 3™ directly from their computer without having to transfer it to an intermediate storage device. All the user needs to do after connecting the data channeling device 10 to the PLAYSTATION 3™ is to use the user interface software 11 to select the media files that he/she wishes to play and these will instantly become visible to the gaming console.

Plug-In Electronic Devices with USB Ports

In the same way as the PLAYSTATION 3™ can play media files, many new DVD players, for example, come with USB ports where users can insert a memory stick which has media content stored on it. The DVD player will be able to read the memory stick and any play movies that are stored on it. In this situation, the data channeling device 10 will again allow users to play their movies directly from their hard drive without having to transfer them to a flash memory drive. Because the data channeling device 10 will be seen by the DVD player as a regular memory stick, the user can then use the user interface software 11 to mark the movies he/she wishes to play and these will become visible to the DVD player.

New Devices with USB Port

Many new electronic devices that are appearing in the market nowadays (such as TVs, digital photo frames, IT equipment, etc) are starting to appear with USB ports. These USB ports are mainly intended for the user to be able to upload information into these devices or to run specific files on the device. This is usually done by first pre-loading such files into a memory stick and then connecting and downloading these files into the device. Again, here the data channeling device 10 can replace the traditional memory stick by allowing the user to connect the data channeling device 10 directly to any device and, through the user interface software 11, choose the files that become visible to the device. This will make using the USB port functionalities of these new devices faster and simpler.

The present invention is thus able to shed the traditional dependencies of memory chip limitations by bringing together the traditional USB flash drive concept with a wireless backend. In addition, the functionality of the data channeling device controller 24 is considered novel and unique. In particular, the data channeling device controller 24 provides a set of functions one of which is mediation, which allows translation of data packets from UMS protocol to 802.11 protocol and vice-versa.

1. A wireless data channeling device associated with a host computer device, the host computer device comprising data that is deemed to be visible with respect to the data channeling device, the data channeling device comprising:
a connector to allow the device to be fitted to a device that is remote from the host computer;
a device transceiver to enable the device to receive/transmit data from/to a host transceiver of the host computer device; and
a controller for functionally connecting the connector to the host transceiver so that, when in a data channeling mode, the visible data on the host computer device can be wirelessly transmitted to the remote client device via the data channeling device and/or data on the remote client device can be transmitted to the host computer device via the data channeling device.

2. The wireless data channeling device of claim 1, wherein the connector resembles a connector of a conventional USB flash memory disk, with the controller having firmware so that, when connected to the remote client device, the data channeling device mimics a conventional memory stick.

3. The wireless data channeling device of claim 1, wherein the data channeling device comprises a pairing switch to enable the device to be switched between the data channeling mode and a pairing mode in which the data channeling device is paired to the host computer device.

4. The wireless data channeling device of claim 1, wherein the device transceiver comprises a wireless device transceiver utilizing a wireless technology that allows the data channeling device to be bridged to the host computer.

5. The wireless data channeling device of claim 4, wherein the wireless device transceiver of the data channeling device is paired to a corresponding wireless host transceiver of the host computer device so that the two wireless transceivers can create a wireless bridge between them through which data can be transferred in real time.

6. The wireless data channeling device of claim 5, wherein the wireless transceivers communicate with each other using a WI-FI™ 802.11 wireless communications protocol.

7. The wireless data channeling device of claim 6, wherein a WI-FI™ signal of the host computer device can be split into a plurality of signals, at least one of which is used to create the wireless bridge.

8. The wireless data channeling device of claim 1, wherein the controller is arranged to format the data being transferred from the host computer device to the remote client device so that it can be read by the remote client device.

9. The wireless data channeling device of claim 1, wherein the data channeling device comprises a LED indicator to indicate the signal strength between the data channeling device and the host computer device.

10. A method of pairing a wireless data channeling device with a host computer device, the host computer device comprising data that is deemed to be visible with respect to the data channeling device and further comprising a host transceiver, the data channeling device comprising a connector to allow the device to be fitted to the host computer device and to a remote client device that is remote from the host computer device, a device transceiver to enable the device to receive/transmit data from/to a host transceiver of the host computer device, and a controller for functionally connecting the connector to the host transceiver, the method comprising the steps of:
installing user interface software associated with the data channeling device onto the host computer device;
selecting a pairing mode on the data channeling device;
connecting the data channeling device to the host computer device;
activating the user interface software, this prompting a user to confirm that the data channeling device is to be paired with the host computer device; and
once confirmed, programming the device transceiver to be bridged only to the host transceiver.

11. The method of claim 11, further comprising removing the data channeling device from the host computer device and selecting a data channeling mode on the data channeling device so that the visible data on the host computer device can be wirelessly transmitted to the remote client device via the data channeling device and/or data on the remote client device can be transmitted to the host computer device via the data channeling device.

12. A wireless data channeling system comprising:
a host computer device, the host computer device comprising data that is deemed to be visible; and
a data channeling device comprising:
a connector to allow the device to be fitted to a remote client device that is remote from the host computer device,
a device transceiver to enable the device to receive/transmit data from/to a host transceiver of the host computer device; and
a controller for functionally connecting the connector to the host transceiver so that, when in a data channeling mode, the visible data on the host computer device can be wirelessly transmitted to the remote client device via the data channeling device and/or data on the remote client device can be transmitted to the host computer device via the data channeling device.
